(19) United States
(12) Patent Application Publication
(10) Pub. No.: US 2014/0059648 A1
(43) Pub. Date: Feb. 27, 2014

(54) METHODS FOR SECURE DISTANCE BOUNDING/RANGING BETWEEN TWO DEVICES

(71) Applicants: Boris Danev, Zurich (CH); Srdjan Capkun, Zurich (CH); David Basin, Ruschlikon (CH)

(72) Inventors: Boris Danev, Zurich (CH); Srdjan Capkun, Zurich (CH); David Basin, Ruschlikon (CH)

(73) Assignee: ETH ZUERICH, Zuerich ETH-Zentrum (CH)

(21) Appl. No.: 13/984,810

(22) PCT Filed: Feb. 13, 2012
(86) PCT No.: PCT/CH12/00040

§ 371 Date: Nov. 15, 2013

(30) Foreign Application Priority Data
Feb. 11, 2011 (EP) 11001133.5

(51) Int. Cl. H04W 12/06

(52) U.S. Cl. CPC H04W 12/06
USPC 726/3

(57) ABSTRACT

A method for communicating between a first device and a second device is shown. The devices are structured and configured for communicating via a communication channel by exchanging messages. The method comprises:
a) the first device transmits N≧2, challenge messages to the second device;
b) for each of said N challenge messages, the second device, in reaction to receiving the respective challenge message, carries out a processing on the respective received challenge message and thereby generates a respective response message, and transmits the respective response message to the first device;
c) the first device receives the transmitted N response messages and determines, for at least one of the received response messages, a time elapsed between the transmitting of the respective challenge message and the reception of the respective response message;
d) the first device computes, in dependence of said determined time or times, of a value indicative of a travelling speed of the challenge and the response messages and of a value indicative of a processing time assumed to be required by the second device for carrying out said processing, a value relating to a distance between the first and the second device.

### TECHNICAL FIELD

The invention relates to the field of wireless communication, in particular to the field of wireless communication networks, more particularly to authentication and access control for devices controlled by wireless communication. It relates to methods and apparatuses according to the opening clauses of the claims.

### BACKGROUND OF THE INVENTION

Distance bounding, as a concept, was first proposed by Brands and Chaum in “Distance bounding protocols” by Stefan Brands and David Chaum, in EUROCRYPT '93, pages 344-359, Secaucus, N.J., USA, 1994, Springer-Verlag New York, Inc. They introduced techniques enabling a verifier to determine an upperbound on the physical distance to a prover. In addition, they considered the case where the verifier also authenticates the prover in addition to establishing the distance bound.

### SUMMARY OF THE INVENTION

The methods and corresponding devices and systems described in the following enable secure distance bounding and/or distance ranging. The methods involve two parties (devices), a verifier V and a prover P, equipped with analog and digital processing units.

The prover P modulates incoming challenges from the verifier V using analogue and/or digital processing with minimal processing and negligible variance (these issues are explained in more detail further below in the present patent application). The term “challenge” is sometimes used as a shorthand for challenge message or challenge signal. The modulation of the incoming challenge is effectuated by time and/or code division techniques. Thus, time division techniques, code division techniques or both, can be applied by the prover P for modulating challenges received from the verifier V.

The secure protocols typically consist of a setup, distance measurement and optional validation phases detailed below. In other words, for the communication between the prover P and the verifier V, a protocol is used which usually comprises a setup phase and a distance measurement phase. In addition, the protocol may comprise a validation phase.

The method for communicating is described in the patent claims, as are corresponding devices and systems. Yet, certain aspects of the invention are described in the following.

The invention relates in particular to a method for communicating between a first device and a second device. The first and second devices are structured and configured for communicating via a communication channel by exchanging messages. The method comprises the steps of
a) the first device transmitting N≧2, in particular N≧16, challenge messages to the second device;
b) for each of said N challenge messages, the second device, in reaction to receiving the respective challenge message, carrying out a processing on the respective received challenge message and thereby generating a respective response message, and transmitting the respective response message to the first device;
c) the first device receiving the transmitted N response messages and determining, for at least one of the received response messages, in particular for each of the received N response messages, a time elapsed between the transmitting of the respective challenge message and the reception of the respective response message;
d) the first device computing, in dependence of said determined time or times, of a value indicative of a travelling speed of the challenge and the response messages and of a value indicative of a processing time assumed to be required by the second device for carrying out said processing, a value relating to a distance between the first and the second device.

As an optional feature, said transmitting of the respective response message mentioned in step b) is carried out without a prior demodulation of the challenge message. E.g., transceiver of the prover can be structured and configured in such a way. This can make possible a particularly early transmission of the nonce back from prover P to verifier V.

The number N is an integer, usually N≧8, rather N≧32. N=1 is generally possible, too. The N challenge messages are usually transmitted consecutively.

Usually, each response message is obtained based on a different one of the challenge messages. In other words, the second device generates for each challenge message a corresponding response message. Each response message can therefore be attributed to a single corresponding challenge message.

The steps a) to d) as described above are usually initiated in the indicated sequence.

As an optional feature, the processing time is not time-dependent and in particular independent of the received challenge message. The processing time of the second device may be identical for all N response messages. The processing time being not time-dependent (or independent of time) means that processing carried out at different times requires (with high precision) the same processing time.

As a further optional feature, said processing time has a negligible variance. Said variance is explained further below in the present patent application.

As a further optional feature, the method comprises carrying out, prior to step a), the step of
e) communicating between said first and second devices details of the processing to be carried out in step b).

During step e) and therefore prior to step a), the first and second devices may agree on details of the processing to be carried out in step b). The first and second devices may exchange said details in step e).

As a further optional feature, step e) comprises exchanging a nonce, in particular wherein the nonce is an N bit number (i.e. a number of N bits).

As a further optional feature, in dependence of said nonce, a selection between at least two different ways of processing is carried out. In particular, a selection may be made between exactly two ways of processing.

As a further optional feature in a method which comprises exchanging a nonce in step e), for the n-th of the N transmitted challenge messages, a first of two pre-determined types of processing is applied to the n-th challenge message in order to obtain the n-th response if the n-th digit of said nonce in binary representation is 0, and a second of said two pre-determined types of processing is applied to the n-th challenge message in order to obtain the n-th response if the n-th digit of said nonce in binary representation is 1.

The number n therefore varies between 1 and N, i.e. 1≦n≦N. The optional feature described above can be described in other words as a bit-wise selection between two pre-determined types of processing, according to a digital representation of the nonce. A first challenge message is processed according to value of the a first bit of the nonce exchanged in step e), a second challenge message is processed according to a value of the second bit of said nonce and so forth. When the value of the corresponding bit is 0, a first of the two pre-determined types of processing is applied. When the value of the corresponding bit is 1, a second of two pre-determined types of processing is applied.

We want to point out that the term “response” does not denote the same as the term “response message”. The response is the event itself, the physical embodiment. It comprises the response message. The response thus, in contrast to the response message, also comprises the information at which time the response message is transmitted.

As a further optional feature, said processing carried out in step b) comprises delaying the respective challenge messages, in particular by a pre-determined delay time, more particularly by one of two or more pre-determined delay times.

In particular, the method may comprise exactly two delay times.

As a further optional feature, said processing carried out in step b) comprises spreading the respective challenge message using a spreading code, in particular using a pre-determined spreading code, more particularly using one of two or more pre-determined spreading codes.

In particular, the method may comprise exactly two spreading codes.

As a further optional feature, the method comprises the step of the first device verifying the received responses, based on determining the applied processing, in particular based on determining delay times applied by the second device to the respective challenge messages and/or by determining or verifying a spreading code applied by the second device to the respective challenge messages.

As a further optional feature of a method comprising the step of the first device verifying the received response messages, the method furthermore comprises enabling a controlling of said first device, in particular allowing to access said first device, by said second device only provided that a result of said verifying is positive.

As a further optional feature, the method enables a controlling of said first device, in particular allowing to access said first device, by said second device only provided that said value relating to the distance between the first and the second device is indicative of a distance smaller than a pre-defined maximum distance.

As a further optional feature, the second device is structured and configured for controlling the first device and/or is a reader for reading data from the first device.

As a further optional feature, said communication channel is based on RF communication.

The invention in particular furthermore relates to a device, referred to as verifier, structured and configured for communicating via a communication channel with a further device, referred to as prover, the verifier comprising a transceiver for sending and receiving messages via said communication channel, the verifier being structured and configured for
exchanging messages with the prover via said communication channel;
consecutively transmitting N≧2, in particular N≧16, challenge messages to the prover;
receiving N response messages transmitted by the prover, each of said N response messages being obtained from a respective one of said N challenge messages by processing;
determining, for at least one of the received response messages, in particular for each of the received N response messages, a time elapsed between the transmitting of the respective challenge message and the reception of the respective response message;
computing a value relating to a distance between the verifier and the prover, wherein said computing is carried out in dependence of said determined time or times, of a value indicative of a travelling speed of the challenge and the response messages and of a value indicative of a processing time assumed to be required by the prover for carrying out said processing;
depending on the computed value, to accept or not accept data from the prover, and optionally also to control access to the verifier.

And, the invention in particular furthermore relates to another device, namely to a device referred to as prover, structured and configured for communicating via a communication channel with a further device, referred to as verifier, the prover comprising a transceiver for sending and receiving messages via said communication channel, the prover being structured and configured for
exchanging messages with the verifier via said communication channel;
receiving N≧2, challenge messages consecutively transmitted by the verifier;
for each of said N challenge messages, in reaction to receiving the respective challenge message, carrying out a processing on the respective received challenge message and thereby generating a respective response message, and transmitting the respective response message to the verifier.

It can be provided that the processing is carried out in a processing unit of the prover.

It is to be noted that for carrying out the invention, it can be sufficient to transmit all messages via one and the same communication channel, in particular wherein that communication channel can be full duplex or possibly even a half duplex communication channel.

Further embodiments and advantages emerge from the dependent claims and the figures.

### BRIEF DESCRIPTION OF THE DRAWINGS

Below, the invention is described in more detail by means of examples and the included drawings. The figures illustrate schematically:

FIG. 1 secure distance bounding by two or more time delay circuits in analog domain;

FIG. 2 secure distance ranging by two or more time delay circuits in digital domain;

FIG. 3 secure distance bounding using code division multiplexing in analog domain;

FIG. 4 secure distance ranging using code division multiplexing in digital domain.

The described embodiments are meant as examples and shall not confine the invention.

### DETAILED DESCRIPTION OF THE INVENTION

With reference to the Figures, a couple of ways of carrying out the invention are described in the following.

### First Method for Secure Distance Bounding Between Two Devices

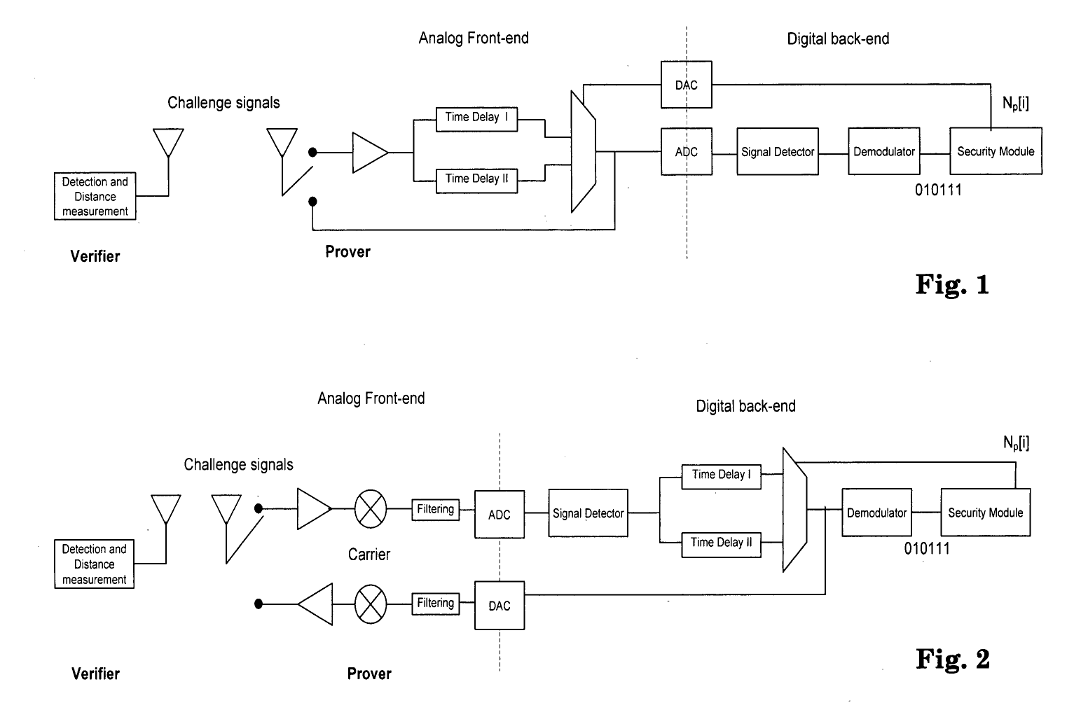

Reference is made to FIG. 1. The verifier V indicated on the left hand side of FIG. 1 and the prover P indicated on the right hand side of FIG. 1 are operationally connected, typically in a wireless fashion, e.g., based on RF (radiofrequency) signals, the triangles standing on their respective tops illustrating transceivers. Challenge signals are transmitted from verifier V to prover P, and in return, prover P transmits responses to verifier V, wherein the responses are derived from the challenge signals. Processing comprised in said deriving comprises delaying the challenge signals received from the verifier V. Usually, two channels providing a different delay for challenge signals, are provided, but it would also be possible to provide more than two. E.g., one or more filters may be used for accomplishing the desired delays in the channels. Prover P comprises a security module in which a nonce Nₚ, i.e. a number only used once, usually generated by a random number generator and usually represented in binary form, is comprised, wherein, usually, it will be provided that the generation of the nonce Nₚ is done in the security module (or elsewhere in prover P) or at least in the prover P. In dependence of nonce Nₚ, it is decided, which signal shall be transmitted to verifier V, more concretely, in the illustrated case, whether the challenge signal as delayed in channel I (Time Delay I) or the challenge signal as delayed in channel II (Time Delay II) shall be transmitted.

### Summary of First Method

The verifier V sends challenge messages to the prover on a single channel
The prover P processes the challenges by a number of filters with different group delay or a chain of filters or other mechanisms to delay in time (cf. “Time Delay I” and “Time Delay II” in FIG. 1)
A security component comprised in prover P decides (in dependence of a nonce Nₚ) which one of the time delayed challenges (I or II) to be reflected back to the verifier V (as a response)
The method can be realized in analog or digital depending on the bandwidth

### Protocol Sketch:

1. During setup phase, the verifier V identifies itself, namely to prover P. Both verifier V and prover P agree on a nonce Nₚ to be used to reflect messages or, more precisely, to be used to select one of (at least) two delay channels in the prover P, wherein the signal as delayed in the selected delay channel will be transmitted (as a response from prover P) to verifier V.
2. During distance bounding phase, the verifier V starts sending challenges (e.g., pulses or non-modulated carrier signals or any signals). Each consecutive challenges are sent by the verifier with a random (only known to the verifier) time delay between them. In other words challenge signals (which may be signals of any kind) are consecutively transmitted by the verifier V, wherein the distance in time between any two consecutive challenge signals is random and not known (before transmitting the challenges) outside the verifier or at least not known to the prover.
3. The received signals at the prover are passed through two different time delay paths (channel I and channel II). For example: The first path delays the signal with a time (substantially) equal to the challenge duration via a delay circuit, and the second path delays the challenge with an arbitrary (but fix) time (also via a delay circuit). This arbitrary time can be a delay time set in the prover P.
4. The prover P reflects back (i.e. transmits back) one of the two delaying paths (I or II) according to nonce N. All signals are recorded via analog-to-digital conversion.
5. The verifier measures the time between its challenges and its reception of the prover's modulated response. Verifier V comprises a time measurement unit for determining, for each transmitted challenge signal, the time elapsed between the sending of the respective challenge signal and the reception of the corresponding response sent by the prover, wherein the response is derived from the respective challenge signal, by modulation, more particular by delaying. E.g., the time between the beginning of the sending of a challenge and the beginning of the reception of the corresponding response can be measured, or the time between the end of the sending of a challenge and the end of the reception of the corresponding response, or a cross-correlation function may be applied to the challenge and to the corresponding response, mutually shifting them in time, the time shift at the cross-correlation maximum indicating the sought time (with high accuracy).
6. During validation, the prover P and verifier V check the security by processing (detection, demodulation) of all exchanged challenges and responses. In other words, it is verified by verifier V that the sequence of time delays extracted from the sequence of received responses reflects nonce Nₚ, and verifier V can verify that the response indeed corresponds to the respective challenge. Thus, e.g., a secure access by prover P to a device controlled by verifier V can be ensured.

Therein, steps 2 to 5 are steps of the distance measurement phase (also referred to as distance bounding phase).

### Second Method for Secure Distance Ranging Between Two Devices

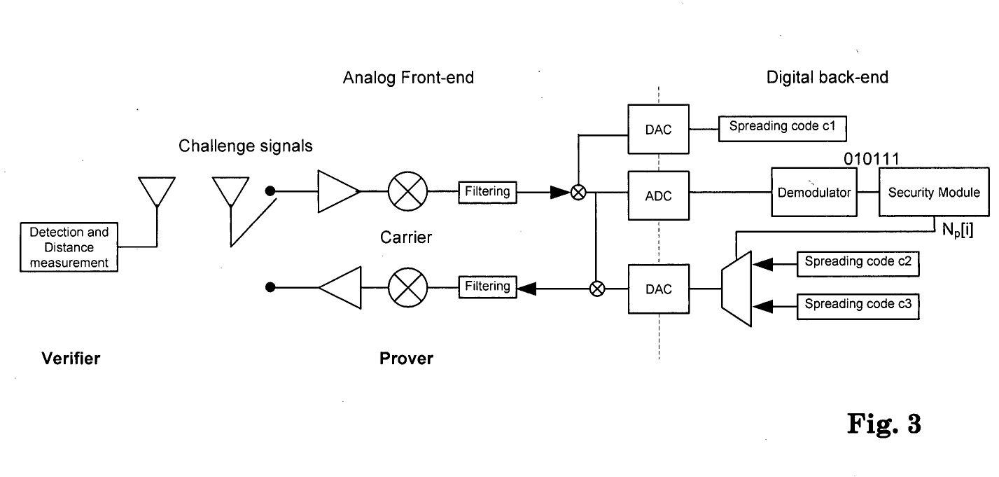

Reference is made to FIG. 2. The verifier V indicated on the left hand side of FIG. 2 and the prover P indicated on the right hand side of FIG. 2 are operationally connected, typically in a wireless fashion, e.g., based on RF (radiofrequency) signals, the triangles standing on their respective tops illustrating transceivers. Challenge signals are transmitted from verifier V to prover P, and in return, prover P transmits responses to verifier V, wherein the responses are derived from the challenge signals. Processing comprised in said deriving comprises delaying the challenge signals received from the verifier V. Usually, two channels providing a different delay for challenge signals, are provided, but it would also be possible to provide more than two. E.g., one or more filters may be used for accomplishing the desired delays in the channels. Prover P comprises a security module in which a nonce Nₚ, i.e. a number only used once, usually generated by a random number generator and usually represented in binary form, is comprised, wherein, usually, it will be provided that the generation of the nonce Nₚ is done in the security module or elsewhere in the prover P or in verifier V. Nonce Nₚ is initially communicated between verifier and prover, as are the delay times to be used in the delay channels.

In dependence of nonce Nₚ, it is decided, which signal shall be transmitted to verifier V, more concretely, in the illustrated case, whether the challenge signal as delayed in channel I (agreed-upon Time Delay I) or the challenge signal as delayed in channel II (agreed-upon Time Delay II) shall be transmitted.

Delaying is, in the embodiment illustrated in FIG. 2, carried out in the digital domain. Two modulators/demodulators (indicated as “Carrier”) are provided for modulation/demodulation for the signal transmission between verifier and prover.

### Summary of Second Method

The verifier sends signals (messages; challenge signals; challenge messages; challenges) to the prover on a single channel, e.g., wirelessly, e.g., in the RF range.
The verifier and prover agree on the different time delays to be introduced to the challenges sent by the verifier. More particularly: During the setup phase, verifier and prover agree upon the delay times to be used in the different delay channels in the prover and upon a nonce Nₚ. Selection between the delay channels will be made in dependence of nonce Nₚ. The correspondingly delayed challenges are then transmitted from prover P to verifier V as responses.
Thus, data can be encoded in the time delays, namely the nonce Nₚ.
Optional signal detection, based preferably on energy detection can be used, in which case the mere presence of a challenge message is detected by detecting the presence of (radiation) energy. This can contribute to the security of the process, making malicious attacks very hard or impossible. This can make possible a simple and high-speed detection that the transmitting-back of the challenge message has to be initiated. This can make possible a particularly early transmission of the responses.

### Protocol Sketch:

1. During setup phase, the verifier identifies itself, namely versus prover P. Both verifier and prover agree on Nₚ (a nonce, e.g., generated in prover P, or generated in verifier V) to be used to reflect messages. The verifier and the prover also agree on a random set of time delays to be introduced to the verifier challenges (pulses, non-modulated or modulated carrier) by the prover. Data can also be encoded in the time delays. Accordingly, in the setup phase, verifier identification takes place; both, verifier and prover agree upon a (secret) nonce; the time delays to be set (as constant values) in the (at least) two delay channels of the prover are agreed upon between prover and verifier, wherein these time delays may be chosen beforehand by random. Which one of the delay channels (and thus which one of the agreed time delays) shall be used for obtaining a response from a challenge message, is selected in dependence of the nonce Nₚ. The challenge signals may be, e.g., pulse signals or modulated or not-modulated carrier signals.
2. During distance bounding phase (distance measurement phase), the verifier starts sending challenges (signals), wherein the sending of the challenges may be periodical or non-periodical, taking place in a pre-defined or in a random sequence, and the receiver (i.e. the prover) reflects back these according to agreed time delays. The time delays are introduced with minimal variance (e.g., group delay filters) in order to allow accurate measurement. Accordingly, the sending-back by the prover of received challenges is carried out selecting (in dependence of Nₚ) from the before-agreed-upon delay times to be used for the delay channels, wherein the delaying is accomplished so as to have a high reproducibility, i.e., when accomplishing a delay by means of any of the delay channels repeatedly, the deviation of the so-accomplished delay times from a mean value is small, e.g., smaller than the mean value at least by a factor of 10, rather by a factor of 100. For accomplishing delays with such a good reproducibility (and thus with a negligible variance), e.g., group delay filters may be used.
3. As has been put forward in point 2 already, the prover reflects back the delayed challenges according to Nₚ. I.e., as indicated before, the selection of the delay channel from which the response by the prover shall be taken, is done in dependence of Nₚ.
4. The verifier measures the time between its challenges and its reception of the prover's modulated response. Verifier V comprises a time measurement unit for determining, for each transmitted challenge signal, the time elapsed between the sending of the respective challenge signal and the reception of the corresponding response sent by the prover, wherein the response is derived from the respective challenge signal, by modulation, more particular by delaying. E.g., the time between the beginning of the sending of a challenge and the beginning of the reception of the corresponding response can be measured, or the time between the end of the sending of a challenge and the end of the reception of the corresponding response, or a cross-correlation function may be applied to the challenge and to the corresponding response, mutually shifting them in time, the time shift at the cross-correlation maximum indicating the sought time (with high accuracy). Therein, the influence of the voluntarily introduced delay times shall firstly be obliterated.
5. During validation, the prover and verifier check the security by processing (detection, demodulation) of all exchanged challenges and responses. This can contribute to the security of the process, making malicious attacks very hard or impossible. E.g., if it is detected by verifier V that other delay times are used than the two delay times agreed upon during the setup phase (e.g., a delay time of 10 microseconds for one delay channel and a delay time of 25 microseconds for the second delay channel), or if it is detected by verifier V that the sequence of delay times applied to obtain consecutive responses does not correspond to the sequence of bits in a binary representation of nonce Nₚ, the (alleged) prover will not be allowed to control the verifier.

Therein, steps 2 to 4 are steps of the distance measurement phase (also referred to as distance bounding phase).

Third Method for Secure Distance and/or Ranging Bounding Between Two Devices

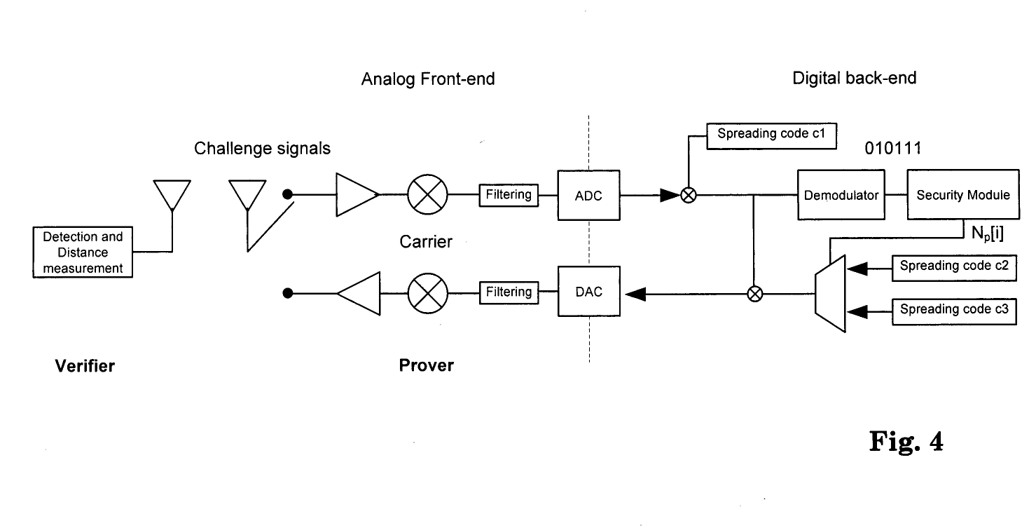

Reference is made to FIGS. 3 and 4. The verifier V indicated on the left hand side of FIGS. 3 and 4, respectively, the prover P indicated on the right hand side of FIGS. 3 and 4, respectively, are operationally connected, typically in a wireless fashion, e.g., based on RF (radiofrequency) signals, the triangles standing on their respective tops illustrating transceivers. Challenge signals are transmitted from verifier V to prover P, and in return, prover P transmits responses to verifier V, wherein the responses are derived from the challenge signals. Processing comprised in said deriving comprises spreading the challenge signals using one of at least two spreading codes. (Modulating signals using a spreading code is a well-known technique and thus does not need to be explained any further in the present patent application.) Usually, two different spreading codes, are provided, but it would also be possible to provide more than two. Prover P comprises a security module in which a nonce Nₚ, i.e. a number only used once, usually generated by a random number generator and usually represented in binary form, is comprised, wherein, usually, it will be provided that the generation of the nonce Nₚ is done in a security module of prover P or elsewhere in prover P or in verifier V. In dependence of nonce Nₚ, it is selected, which signal shall be transmitted to verifier V, more concretely, in the illustrated case, whether the challenge signal as spread using spreading code c2 or the challenge signal as spread using spreading code c3 shall be transmitted.

The challenges are data agreed upon between verifier and prover, wherein these data are spread using a spreading code c1 before transmitting them from verifier V to prover P, and in prover P, the original data are obtained by demodulating them using spreading code c1.

The spreading codes (c1, c2, c3) may be public, but the data in the challenge messages are security relevant, as is the nonce Nₚ.

The security module can also be used for carrying out the verification of the transmitted data, so as to make malicious attacks hard or impossible.

### Summary of Third Method

Verifier and prover use a code division multiplexing channel (e.g., CDMA “Code Division Multiple Access”)
The verifier sends signals using spreading code c1
The prover reflects back to the verifier by multiplexing using codes c2 and c3, more particularly using either spreading code c2 or c3, the selection of the spreading codes depending on a nonce Nₚ, wherein nonce Nₚ is agreed upon during a setup phase
The codes c1, c2 and c3 are agreed prior to the distance bounding phase (distance measurement phase)
The codes also provide jamming resistant distance bounding and ranging. Interference and malicious attacks are likely to fail.

### Protocol Sketch:

1. During setup phase, the verifier identifies itself, namely to prover P. Both verifier and prover agree on Nₚ (a nonce) to be used to reflect messages, i.e. nonce Nₚ known to verifier and prover will be used during responding to challenges.
2. The verifier and prover agree on the data and spreading codes c1, c2 and c3. For allowing a verification, also prover P needs to know which data are transmitted in the challenge signals, and all employed spreading codes (c1, c2, c3) need to be known to both, prover and verifier.
3. During distance bounding phase, the verifier sends challenge signals spreading with c1. The sending of the c1-spread signals may be accomplished continuously or in portions each constituting a data stream; a continuous data stream should usually be at least as long as it takes to select, in prover P, from c2-spread and c3-spread data in dependence of the full bit-length of Nₚ. The prover reflects back additionally spreading the received challenges using c2 or c3 according to Nₚ, i.e., the prover transmits to the verifier signals which had previously been received as spread using c1 and which, after demodulating the spreading with c1 (i.e. carrying out the inverse of spreading with c1), are spread using either c2 or c3 at any time, the selection of c2 and c3, respectively, depending on Nₚ.
4. The verifier measures the time between its challenges and its reception of the prover's modulated response. When the processing time for the processing in prover P and the signal propagation speed for the communication between verifier and prover is known, an upper limit for the distance between verifier and prover can be obtained, thus enabling distance bounding. In the illustrated example of FIG. 4, the processing time comprises the times required for (i) the demodulation of the carrier signal (cf. “Carrier” in FIG. 4) (ii) the filtering thereafter, (iii) the analog-to-digital conversion, (iv) the demodulation of the spreading with c1, (v) the spreading with c2 or c3, (vi) the digital-to-analog conversion, (vii) the filtering thereafter, and (viii) the modulation of the spread signal onto a carrier signal.
5. During validation, the prover and verifier check the security by processing (detection, demodulation) of all exchanged challenges and responses.

Therein, steps 1 and 2 are steps of the setup phase, and steps 3 and 4 are steps of the distance measurement phase (also referred to as distance bounding phase).

Depending on, e.g., distances between verifier and prover and on data (signal) lengths, it may be necessary to provide full-duplex communication, but it can also be possible to do with half-duplex communication.

As to the minimal computation/processing and the “negligible variance”: The amount of processing involved should deliberately be chosen to be very small, e.g., avoiding a demodulation of a challenge message, and the processing time variance should be so small that it can be neglected, e.g., with respect to the processing time itself. E.g., carrying out the (same) processing several times will result in deviations of the respective processing times which are smaller than the processing time itself by at least a factor of 10, or rather by at least a factor of 100, or even by at least a factor of 1000.

But generally spoken, the acceptable processing time variance (or negligible processing time variance) depends on the application in which the invention shall be used. In case the communication channel has a signal propagation speed of speed of light, acceptable processing time variances will typically be at most 100 ns or rather at most 10 ns or even at most 1 ns. As usually will be the case, access to or control of verifier V by prover P shall be allowed only if a value relating to the distance between verifier V and prover P as computed by verifier V is indicative of a distance smaller than a pre-defined maximum distance referred to as dmax. With c designating the signal propagation speed of the communication channel, the acceptable processing time variance, i.e. the processing time variance which would be considered negligible, would usually be at most 0.2 times dmax/c or rather at most 0.1 times dmax/c or even at most 0.05 times dmax/c.

The method's application areas include those systems controlling access to objects (e.g., vehicles or buildings) and services (e.g., for vehicles, medical devices, or computing devices). The method can be also used for localization of devices by computing their position based on multilateration schemes performing time-of-flight measurements with a set of base stations.

By means of the invention, it is possible to determine a distance between verifier and prover and thus to ensure that a prover is located within a given maximal distance from the verifier. Furthermore, malicious attacks trying to interfere are effectively impeded.

Aspects of the embodiments have been described in terms of functional units. As is readily understood, these functional units may be realized in virtually any number of hardware and/or software components adapted to performing the specified functions.

Furthermore, the following embodiments are disclosed, wherein each of them may be, as far as logically possible, be combined with the invention as described elsewhere in the present patent application.

### METHOD EMBODIMENTS

### Embodiment 1

A method for communicating between a first device and a second device, that is preferably a reader for reading data from the first device and optionally destined for controlling the first device, the method comprising the steps of
the first and second device communicating by exchanging messages based on signals over a communication channel;
the first device sending a challenge message to the second;
the second device sending upon reception of the challenge message a response message to the first device;
the first device measuring the time elapsed between the sending of the challenge message to the reception of the response message;
the first device computing its distance to the second device based on this time, knowledge about travelling speed of the challenge and the response message and the processing delay that the second device adds to generate and send the response message;
   characterised in that the second device has a known calculation time for its response with negligible variance.

### Embodiment 2

The method of embodiment 1, comprising the further step of
the first and second device by exchanging the messages, establish a shared secret key.

### Embodiment 3

The method of embodiment 1 or embodiment 2, comprising the further steps of
defining a fixed nonce length for the first device and a fixed nonce length for the second device;
the first and second device each picking a random nonce of the defined lengths;
the first device encoding its chosen nonce into the challenge message; the second device responds by modulating the challenge message using either analogue or digital processing.

### Embodiment 4

The method of embodiment 3, comprising the further steps of
given a cryptographic key (either a shared secret symmetric key or using public key cryptography), the second device authenticating the nonce it received as well as its own nonce using the key (e.g., signing with its private key or producing a message authentication code with the shared symmetric key) and thus establishing an additional message;
the second device sending that additional message to the first device;
the first device verifying the additional message by knowledge of his chosen nonce and the previously received nonce chosen by the second device.

### Embodiment 5

The method of one of the preceding embodiments, wherein all of the communication channels are based on RF communication.

### Embodiment 6

The method of one of the preceding embodiments, wherein the step of controlling access of the second device to the first device, in addition to the distance, takes into account credential information, such as a device's identity.

### Embodiment 7

The method of one of the preceding embodiments, wherein the first device comprises two or more levels of access, and the method comprises the further step of
the first device controlling access to the different levels of access depending on the value of the computed distance.

### Device Embodiments

### Embodiment 8

A first device, configured to communicate with a further device, comprising
a transceiver for sending and receiving messages;
the device being configured to
   exchange messages;
   to compute the distance to the further device based on communication signal delays and caused by the difference in signal propagation velocities and estimated processing time of the other device; and
   depending on the computed distance, to accept data from the further device and optionally also to control access to the device.

### Embodiment 9

A second device, configured to communicate with a further device, comprising
a transceiver for sending and receiving messages;
analogue and digital processing units to produce and transmit the response with minimal processing and negligible variance, in particular comprising:
   an analogue or digital circuitry to produce a modulated response to the initial challenge by delaying it in time; two or more different time delays are used for modulation;
   an analogue or digital selector to reflect back the modulated response back to the first device, where the processing time between the challenge reception and the modulated response is minimal and with negligible variance.

### Embodiment 10

A second device according to embodiment 9, where the receiving unit is linked to the transmitting unit so that the modulated response is reflected back without demodulation.

### Embodiment 11

A second device according to any of the embodiments 9-10, where the receiving unit has an optional signal detection unit; preferably energy detection unit.

### Embodiment 12

A second device according to any of the embodiments 9-11, where the introduced two or more time delays to the original challenge are used to encode data.

### Embodiment 13

A second device according to any of the embodiments 9-12, where detection and demodulation of the original challenge are done by digital processing in a time non-critical phase.

### Embodiment 14

A second device, configured to communicate with a further device, comprising
a transceiver for sending and receiving messages;
analogue and digital processing units to produce and transmit the response with minimal processing and negligible variance, in particular comprising:
   an analogue or digital circuitry to dispread the initial challenge based on a shared spreading code;
   an analogue or digital circuitry to produce a modulated response of the initial dispread challenge by further spreading with two or more spreading codes;
   an analogue or digital selector to reflect the modulated response back to the first device, where the processing time between the challenge reception and the modulated response is minimal and with negligible variance.

### Embodiment 15

A second device according to embodiment 14, where the receiving unit is linked to the transmitting unit so that the modulated response is reflected back without demodulation;

### Embodiment 16

A second device according to any of the embodiments 14-15, where demodulation of the original challenge are done by digital processing in a time non-critical phase.

By means of the invention, it is possible to determine a distance between verifier and prover and thus to ensure that a prover is located within a given maximal distance from the verifier. Furthermore, malicious attacks trying to interfere are effectively impeded.

Aspects of the embodiments have been described in terms of functional units. As is readily understood, these functional units may be realized in virtually any number of hardware and/or software components adapted to performing the specified functions.

1. A method for communicating between a first device and a second device, the first and second devices being structured and configured for communicating via a communication channel by exchanging messages, the method comprising the steps of:
a) the first device transmitting N≧2 challenge messages to the second device;
b) the first device receiving the transmitted N response messages and determining, for at least one of the received response messages, in particular for each of the received N response messages, a time elapsed between the transmitting of the respective challenge message and the reception of the respective response message;
c) the first device computing, in dependence of said determined time or times, of a value indicative of a travelling speed of the challenge and the response messages and of a value indicative of a processing time assumed to be required by the second device for carrying out said processing, a value relating to a distance between the first and the second device.

2. The method according to claim 1, wherein said processing time is not time-dependent.

3. The method according to claim 1, wherein said processing time has a negligible variance.

4. The method according to claim 1, comprising carrying out, prior to step a), the step of:
e) communicating between said first and second devices details of the processing to be carried out in step b).

5. The method according to claim 4, wherein step e) comprises exchanging a nonce.

6. The method according to claim 5, wherein in dependence of said nonce, a selection between at least two ways of processing is carried out.

7. The method according to claim 5, wherein for the n-th of the N transmitted challenge messages, a first of two pre-determined types of processing is applied to the n-th challenge message in order to obtain the n-th response if the n-th digit of said nonce in binary representation is 0, and a second of said two pre-determined types of processing is applied to the n-th challenge message in order to obtain the n-th response if the n-th digit of said nonce in binary representation is 1.

8. The method according to claim 1, wherein said processing carried out in step b) comprises delaying the respective challenge messages.

9. The method according to claim 1, wherein said processing carried out in step b) comprises spreading the respective challenge message using a spreading code.

10. The method according to claim 1, comprising the step of the first device verifying the received responses, based on determining the applied processing.

11. The method according to claim 1, comprising enabling controlling said first device by said second device.

12. The method according to claim 1, enabling controlling said first device by said second device.

13. The method according to claim 1, wherein the second device is structured and configured for controlling the first device.

14. The method of claim 1, wherein said communication channel is based on RF communication.

15. A device, referred to as verifier, structured and configured for communicating via a communication channel with a further device, referred to as prover, the verifier comprising a transceiver for sending and receiving messages via said communication channel, the verifier being structured and configured for:
exchanging messages with the prover via said communication channel;
consecutively transmitting N≧2 challenge messages to the prover;
receiving N response messages transmitted by the prover, each of said N response messages being obtained from a respective one of said N challenge messages by processing;
determining, for at least one of the received response messages, a time elapsed between the transmitting of the respective challenge message and the reception of the respective response message;
computing a value relating to a distance between the verifier and the prover, wherein said computing is carried out in dependence of said determined time or times, of a value indicative of a travelling speed of the challenge and the response messages and of a value indicative of a processing time assumed to be required by the prover for carrying out said processing;
depending on the computed value, to accept or not accept data from the prover; and
depending on the computed value, control access to the verifier.

16. The device according to claim 15, being furthermore structured and configured for transmitting or receiving via said communication channel at least one message comprising details of said processing to be carried out in the prover.

17. The device according to claim 16, wherein said details comprise a nonce.

18. The device according to claim 15, being furthermore structured and configured for verifying the N received response messages, based on determining the applied processing.

19. The device according to claim 18, being furthermore structured and configured for enabling a controlling of the verifier by the prover only provided that a result of said verifying is positive.

20. A device, referred to as prover, structured and configured for communicating via a communication channel with a further device, referred to as verifier, the prover comprising a transceiver for sending and receiving messages via said communication channel, the prover being structured and configured for:
exchanging messages with the verifier via said communication channel;
receiving N≧2, challenge messages consecutively transmitted by the verifier; and
for each of said N challenge messages, in reaction to receiving the respective challenge message, carrying out a processing on the respective received challenge message and thereby generating a respective response message, and transmitting the respective response message to the verifier.

21. The device according to claim 20, wherein said processing time is not time-dependent.

22. The device according to claim 20, wherein said processing time has a negligible variance.

23. The device according to claim 20, being furthermore structured and configured for transmitting or receiving via said communication channel at least one message comprising details of said processing to be carried out in the prover.

24. The device according to claim 23, wherein said details comprise a nonce.

25. The device according to claim 24, being furthermore structured and configured for selecting, in dependence of said nonce, between at least two ways of processing and carrying out the selected processing.

26. The device according to claim 25, wherein said processing comprises delaying in time, and wherein said at least two ways of processing differ in a time delay applied in the delaying.

27. The device according to claim 25, wherein said processing comprises spreading the respective challenge message using a spreading code, and wherein said at least two ways of processing differ in a spreading code applied in the spreading.

28. The device according to claim 20, comprising analogue and digital processing units for producing and transmitting the responses with negligible variance.

29. A distance bounding system comprising a first device being a device according to one of claim 15 and a second device being a device, referred to as prover, structured and configured for communicating via a communication channel with a further device, referred to as verifier, the prover comprising a transceiver for sending and receiving messages via said communication channel, the prover being structured and configured for:
exchanging messages with the verifier via said communication channel;
receiving N≧2, challenge messages consecutively transmitted by the verifier; and
for each of said N challenge messages, in reaction to receiving the respective challenge message, carrying out a processing on the respective received challenge message and thereby generating a respective response message, and transmitting the respective response message to the verifier.

30. The method of claim 1, wherein in step a), the first device transmits N≧16, challenge messages to the second device.

31. The method according to claim 2, wherein said processing time is independent of the received challenge message.

32. The method according to claim 8, wherein said processing carried out in step b) comprises delaying the respective challenge messages by a pre-determined delay time.

33. The method according to claim 8, wherein said processing carried out in step b) comprises delaying the respective challenge messages by one of two or more pre-determined delay times.

34. The method according claim 9, wherein said processing carried out in step b) comprises spreading the respective challenge message using a spreading code using a pre-determined spreading code.

35. The method according claim 9, wherein said processing carried out in step b) comprises spreading the respective challenge message using one of two or more pre-determined spreading codes.

36. The method according to claim 10, wherein said verification of the received responses is based on determining delay times applied by the second device to the respective challenge messages.

37. The method according to claim 10, wherein said verification of the received responses is based on determining or verifying a spreading code applied by the second device to the respective challenge messages.

38. The method according to claim 11, wherein accessing of said first device by said second device is allowed only if a result of said verifying is positive.

39. The method according to claim 1, wherein accessing of said first device by said second device is allowed only if said value relating to the distance between the first and the second device is indicative of a distance smaller than a pre-defined maximum distance.

40. The method according to claim 1, wherein the second device is a reader for reading data from the first device.

41. The device according to claim 18, wherein said verification of N received messages is based on determining delay times applied by the prover to the respective challenge messages.

42. The device according to claim 18, wherein said verification of N received messages is based on determining or verifying a spreading code applied by the prover to the respective challenge messages.

43. The device according to claim 21, wherein said processing time is independent of the received challenge message.

44. The device according to claim 25, wherein said selecting is carried out by an analogue or a digital selector comprised in the prover.

45. The device according to claim 26, wherein said delaying is carried out by an analogue or a digital time delay unit comprised in the prover.

46. The device according to claim 15, wherein the verifier is structured and configured for wherein consecutively transmitting N≧16 challenge messages to the prover.
